(19) United States
(12) Patent Application Publication
(10) Pub. No.: US 2004/0257907 A1
(43) Pub. Date: Dec. 23, 2004

(54) Method and apparatus for mixing fluids

(75) Inventors: Diao Xu, Singapore (SG); Teng Yong Ng, Singapore (SG); Eng Hann Lim, Singapore (SG); Hua Pan, Singapore (SG); Lunsheng Pan, Singapore (SG); Khin Yong Lam, Singapore (SG)

Correspondence Address: MARTINE & PENILLA, LLP, 710 LAKEWAY DRIVE, SUITE 170, SUNNYVALE, CA, 94085, US

(73) Assignee: Agency for Science, Technology and Research

(21) Appl. No.: 10/600,803

(22) Filed: Jun. 19, 2003

(51) Int. Cl. B01F 11/02

(52) U.S. Cl. 366/127

(57) ABSTRACT

A fluid mixer and a method of mixing a fluid are provided. The fluid mixer comprises a chamber having an inlet and an outlet to receive and to output a fluid, respectively. A partition with a plurality of perforations is provided in the chamber to separate the fluid into fluid segments. The separation lowers a diffusion distance of the fluid to enhance mixing. Thereafter, the fluid is outputted from the chamber.

### BACKGROUND OF THE INVENTION

1. Field of the Invention

The present invention relates generally to fluid mixing. More particularly, the present invention relates to a method and apparatus to mix fluids in a micro total analysis system (μ-TAS).

2. Description of the Related Art

Fluid mixing is at the heart of most systems that analyse bio-chemical processes. In macro engineering, fluid mixing is of great importance in the mining, food, petroleum, chemical, pharmaceutical, and industrial waste treatment industries. It is also important in micro engineering (i.e. mixing at a cellular level), especially for micro total analysis system (μ-TAS) devices.

μ-TAS is loosely defined as a miniaturized device that includes and integrates all necessary parts and methods to perform a chemical analysis/synthesis. The system, which typically includes sample preparation, separation, and detection units, is formed within the confines of a single semiconductor chip. Examples of μ-TASs include microsensors, microactuators, and microfluidic devices. In microfluidic devices, research has always been focused on developing micropumps and valves to manipulate fluids inside a microfabricated structure.

The advantages of μ-TAS devices are closely associated with miniaturisation and integration of chemical and physical processes onto a semiconductor. One of the important goals in the development of μ-TAS devices is to shorten analysis and reaction times as well as to reduce the consumption of power, reagents, and samples. The use of μ-TAS devices also increases sample and product throughput resulting in higher yields and faster analysis when such systems are implemented in parallel.

The rate at which fluids achieve homogeneity in a μ-TAS device is crucial to achieving enhanced performance. Unfortunately, the rate of micromixing in μ-TASs limits overall system performance, particularly where the micromixing time is of the same order as or larger than the characteristic time constant of the reaction. In such cases, the reaction between the sample and reagent occurs simultaneously with the mixing of the two species. Consequently, the reaction may be suppressed as a result of insufficient mixing. Therefore, the development of new micromixing devices is crucial to maximising the potential of μ-TAS devices.

The term micromixing is generally used to describe fluid mixing at the molecular scale. Efficient micromixing in μ-TAS devices is impeded by the tiny size of micromixers (relative to conventional mixers), which prevents the forming of turbulent flow of the fluid. Because the micromixer operates on such a miniaturised scale, fluid flow within the micromixer is predominantly laminar. Therefore, micromixing is accomplished predominantly through the diffusion of molecules between adjacent fluid domains. This process of diffusion occurs as a result of random molecular motion along a concentration gradient and is a time consuming process.

In a laminar flow system, the mixing time, t, that is, the time a molecule takes to diffuse over a diffusion distance, x, is expressed as follows:

$$t = \frac{π {x}^{2}}{4 D} \qquad ( 1 )$$

where D represents the diffusion constant of the diffusing compounds. As evident from equation (1), the efficiency of a micromixer can be increased by minimising the diffusion distance x to reduce the mixing time. To accelerate micromixing, the size of pure individual fluid elements is reduced until the scale of segregation reaches a sufficiently low level for the rate of molecular diffusion to become significant.

Efficient mixing in a laminar flow region can be achieved by applying one of the following principles: elongational flow or distributive mixing. Elongational flow, also known as laminar shear, involves the deformation or stretching of fluid elements to increase the interfacial areas between the fluid elements of the fluids to be mixed. Distributive mixing, on the other hand, involves the physical splitting of fluid streams into smaller segments and redistributing them so that the striation thickness of the laminate streams of the fluids is significantly reduced. The former is accomplished by creating relative motion between the streamlines, whilst the latter is realised by changing flow channel geometry.

“Microstructure for efficient continuous flow mixing” (Anal. Commun. 1999, 36, 213-215) by Fiona G. Bessoth, et al., discloses a micromixer based on the principle of distributive mixing. Specifically, the micromixer splits the flow of two inlet liquids and rearranges them in alternating thin laminae. Unfortunately, this micromixer also requires a relatively high-pressure difference to drive the two inlet liquids through a plurality of tiny channels. Because a small pressure difference would be much more energy efficient, the high-pressure difference requirement is undesirable. In addition, because the Bessoth micromixer is dependant on diffusion to mix fluids, it is not very effective where the fluids have low diffusion coefficients.

As an alternative to minimising the diffusion distance, employing external active elements can also increase the rate of micromixing. One such active micromixer is described in “A minute magneto hydro dynamic (MHD) mixer” (Sensors and Actuators B 79 (2001) 207-215) by Haim H. Bau, et al. The micromixer employs a magneto hydrodynamic (MHD) stirrer to enhance mixing in μ-TAS. The main problem with such a micromixer is that it is only applicable to magnetic solutions. Non-magnetic solutions are unable to react to externally applied magnetic fields. Further, as the MHD micromixer has very small dimensions, it is difficult to generate consistent magnetic fields within the micromixer with a coil of wire.

Another active micromixer employing ultrasonic vibrations is described in “Ultrasonic micromixer for microfluidic systems” (Sensors and Actuators A 93 (2001) 266-272) by Zhen Yang, et al. The ultrasonic vibration is provided by a piece of bulk piezoelectric lead-zirconate-titanate (PZT) excited by a 60 kHz square wave at 50V (peak-to-peak). Unfortunately, the use of ultrasonic vibrations generates heat, which raises the temperature of the micromixer. The ultrasonic waves and the increased temperature may cause damage to cells in a bio-liquid.

In view of the foregoing, it is desirable to have a mixer and method for mixing whose effectiveness is not limited to particular classes of fluids or by micromixer dimensions. It is also desirable to have a mixer and method for mixing that does not generate heat. Additionally, it is also desirable to have a mixer and method for mixing that does not require high voltages and frequencies for operation.

### SUMMARY OF THE INVENTION

The present invention fills these needs by providing a method and apparatus for mixing fluids. It should be appreciated that the present invention can be implemented in numerous ways, including as a process, an apparatus, a system or a device. Several inventive embodiments of the present invention are described below.

In one embodiment of the present invention, a fluid mixer is provided. The fluid mixer comprises a chamber having an inlet and an outlet to receive and to output a fluid, respectively. A partition with a plurality of perforations is provided in the chamber to segment the fluid. The fluid mixer preferably includes a first conductor, coupled to a first side of the chamber, and a second conductor, coupled to a second side of the chamber. An alternating current power source may be coupled between the conductors to generate a capacitance between the first conductor and the second conductor so that the chamber vibrates and enhances mixing.

A substrate is preferably coupled to the second conductor to support the chamber as well as to hold the second conductor steady. The first conductor is preferably parallel the second conductor and may be used to vibrate the fluid. Preferably, the perforations have a diameter of about ten times a diameter of a molecule in the fluid. The inlet preferably includes a plurality of openings to allow the fluid to enter the chamber in a plurality of layered streams. A flow of the fluid through the inlet and the outlet may be perpendicular to a flow of the fluid through the chamber. Alternatively, the partition may be coated with an insulation layer and coupled to the alternating current power source to vibrate the partition.

In another embodiment of the present invention, a method of mixing a fluid is provided. The method begins by receiving the fluid in a chamber and separating the fluid into a plurality of fluid segments to lower a diffusion distance of the fluid. Thereafter, the fluid is outputted from the chamber. The fluid is preferably separated when the fluid flows through a partition having a plurality of perforations.

In a preferred embodiment, the fluid is vibrated by providing a first conductor and a second conductor, and generating a capacitance between the first conductor and the second conductor. Both the first conductor and the second conductor are coupled to the chamber. The fluid may be vibrated by generating an alternating current in the partition to vibrate the partition.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 illustrates a cross-sectional view of a mixer in accordance with one embodiment of the present invention.

FIG. 2 illustrates a top view of a partition in accordance with one embodiment of the present invention.

FIG. 3 illustrates a top view of a mixer in accordance with one embodiment of the present invention.

FIG. 4a illustrates an enlarged side view of an inlet in accordance with one embodiment of the present invention.

FIG. 4b illustrates an enlarged top view of an inlet in accordance with one embodiment of the present invention.

FIG. 5 illustrates a cross-sectional view of a mixer in accordance with another embodiment of the present invention.

FIG. 6a illustrates a top view of a mixer in accordance with yet another embodiment of the present invention.

FIG. 6b illustrates a cross-sectional view of a mixer in accordance with yet another embodiment of the present invention.

FIG. 7 illustrates a method of mixing a fluid in accordance with one embodiment of the present invention.

### DETAILED DESCRIPTION OF THE PREFERRED EMBODIMENTS

A method and apparatus for mixing fluids are provided. In the following description, numerous specific details are set forth in order to provide a thorough understanding of the present invention. It will be understood, however, to one skilled in the art, that the present invention may be practiced without some or all of these specific details. In other instances, well known process operations have not been described in detail in order not to unnecessarily obscure the present invention.

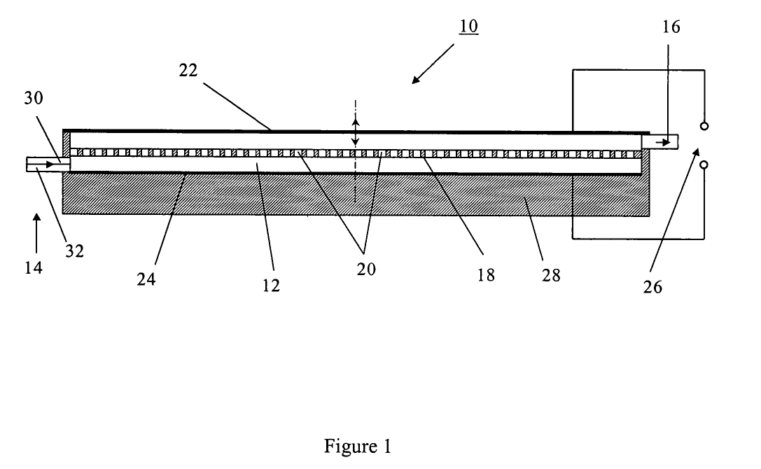

FIG. 1 illustrates a cross-sectional view of a mixer 10 in accordance with one embodiment of the present invention. Mixer 10 comprises a chamber 12 with an inlet 14 to receive a fluid and an outlet 16 to discharge the fluid after mixing has occurred. Mixer 10 may also receive a number of different fluids for mixing, however for exemplary purposes a single fluid is used. A partition 18 having a plurality of perforations 20 is provided inside chamber 12. A first conductor 22 is provided on a side of chamber 12, preferably parallel to partition 18. A second conductor 24 is provided on another side of chamber 12, preferably parallel to first conductor 22.

Both first conductor 22 and second conductor 24 are preferably coupled to an alternating current (AC) power source 26. Mixer 10 is supported by a substrate 28. Chamber 12 is preferably coated with an insulation layer to prevent electrical disruption in mixer 10. First conductor 22 is also preferably coated with an insulation layer to reduce current leakage. Inlet 14 includes a first opening 30 and a second opening 32. First opening 30 and second opening 32 are configured to allow the fluid to enter chamber 12 in a plurality of layered streams.

After entering chamber 12, the fluid flows through plurality of perforations 20 in partition 18. Perforations 20 are used to split and separate the fluid into smaller portions referred to as fluid segments. With reference to equation (1) above, segmentation of the fluid reduces diffusion distance x between the fluid segments and therefore, reduces mixing time t.

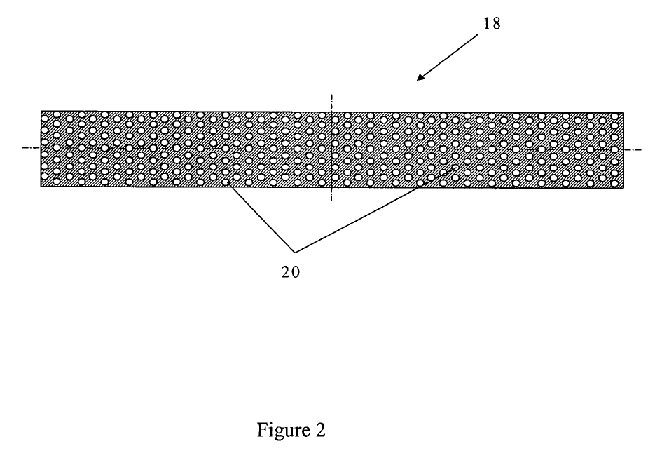

A top view of partition 18 is illustrated in FIG. 2 in accordance with one embodiment of the present invention. Partition 18 sections chamber 12 into an upper chamber and a lower chamber. The shape, size, and arrangement of each perforation 20 may be altered to suit the characteristics of the fluid. For example, a fluid with large molecules or cells will require larger perforations than one with small molecules or cells. Preferably, the diameters of perforations 20 are about ten times the diameter of the fluid molecules.

Referring back to FIG. 1, an alternating current from AC power source 26 may be applied to first conductor 22 and second conductor 24 causing first conductor 22 to vibrate. The vibration is a result of the change in capacitance induced by the alternating current. The vibration of first conductor 22 pushes the fluid inside chamber 12 to and away from partition 18. During the vibration, the fluid is broken down into even smaller fluid segments, which increases the interface between fluid segments. Diffusion between the fluid segments is enhanced because of the reduction in diffusion distance.

The vibrations of first conductor 22 may be configured to follow selected vibration patterns, such as a cosine curve. The vibrations create flow patterns that enhance mixing in chamber 12. The power required to vibrate first conductor 22 is inversely proportional to the size of perforations 20 in partition 18. A fluid passing through small perforations instead of large perforations will require greater power to cause the same magnitude of diffusion. Therefore, a higher voltage is required when smaller perforations are used. The applied voltage is preferably about or less than 5 Volts, but may also depend on the application of integrated circuit devices.

First conductor 22 and second conductor 24 are preferably formed from a pliable and conductive material such as aluminium or copper. Second conductor 24 will not vibrate if substrate 28 is made of a rigid material such as silicon. Additionally, mixer 10 is operable at low frequencies of vibration of about less than 100 Hertz. For example, a frequency of about 40 Hertz (Hz) is sufficient to ensure adequate mixing of a liquid with a diffusion coefficient of 10⁻¹⁰ m²/s. Low frequencies of vibration are preferred as such frequencies may cause less damage to sensitive fluids, such as cells in a bio-liquid.

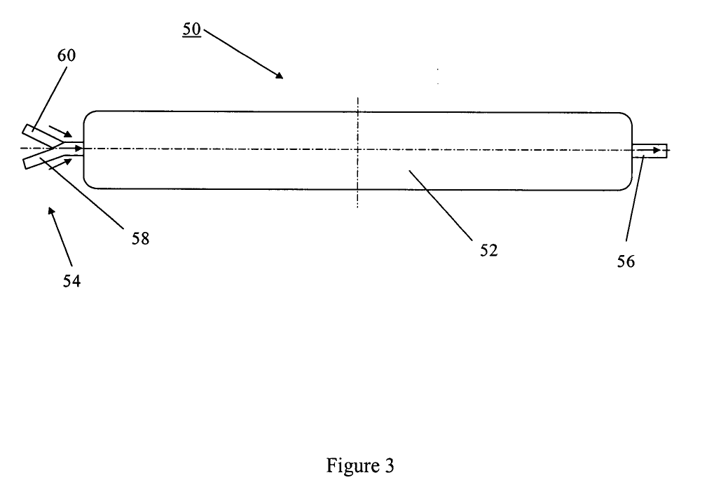

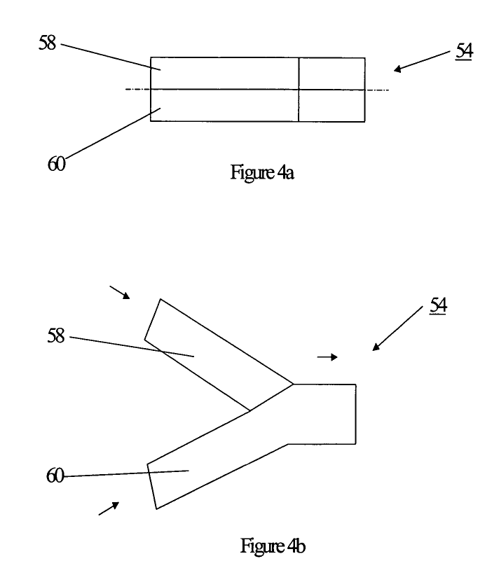

FIG. 3 illustrates a top view of a mixer 50 in accordance with one embodiment of the present invention. Mixer 50 comprises a chamber 52 with an inlet 54 to receive a fluid and an outlet 56 to discharge the fluid. In this embodiment, inlet 54 is a two-way junction. An enlarged view of inlet 54 is illustrated in FIG. 4a and FIG. 4b.

FIG. 4a illustrates an enlarged side view of inlet 54 in accordance with one embodiment of the present invention. Inlet 54 comprises a two-way junction with a first opening 58 and a second opening 60. FIG. 4b illustrates an enlarged top view of inlet 54 in accordance with one embodiment of the present invention. First opening 58 and second opening 60 direct the fluid streams so that the two fluids enter chamber 52 in layered streams. Inlet 54 may be modified to include additional openings to receive additional fluids.

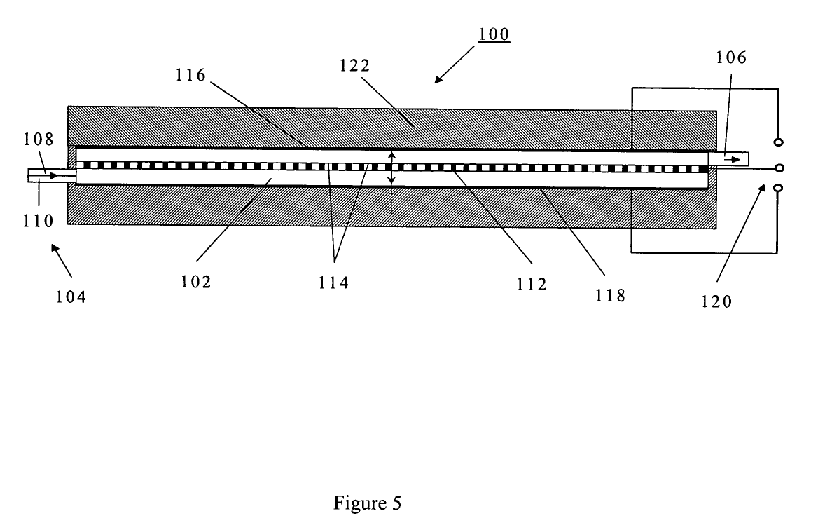

FIG. 5 is a cross-sectional view of a mixer 100 in accordance with another embodiment of the present invention. Mixer 100 comprises a chamber 102 with an inlet 104 to receive a fluid and an outlet 106 to discharge the fluid after mixing. Inlet 104 includes a first opening 108 and a second opening 110. A partition 112 having a plurality of perforations 114 is provided inside chamber 102.

A first conductor 116 is provided on one side of chamber 102, preferably parallel to partition 112. A second conductor 118 is provided on another side of chamber 102, preferably parallel to first conductor 116. First conductor 116, second conductor 118 and partition 112 are connected to an alternating current (AC) power source 120. Mixer 100 is supported in a housing 122. Chamber 102 and partition 112 are preferably coated with an insulation layer (not illustrated in this embodiment) to prevent a flow of electric current to the fluid.

When an alternating current is applied to mixer 100, the capacitance between partition 112 and conductors 116 and 118 changes, generating an electrostatic force, which results in the vibration of partition 112. In this embodiment, first conductor 116 and second conductor 118 do not vibrate as they are held rigidly in place by housing 122. The vibration of partition 112 causes the fluid inside chamber 102 to break down into even smaller fluid segments.

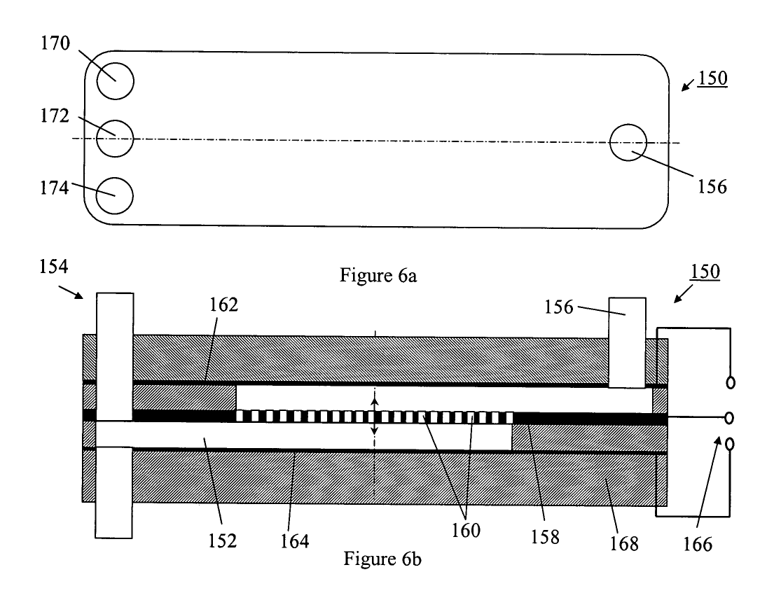

FIGS. 6a and 6b illustrate a mixer 150 in accordance with yet another embodiment of the present invention. FIG. 6a illustrates a top view of mixer 150, whilst FIG. 6b illustrates a cross-sectional view of mixer 150. Referring to FIG. 6b, mixer 150 comprises a chamber 152 with an inlet 154 to receive a fluid and an outlet 156 to discharge the fluid after mixing has occurred. A partition 158 with a plurality of perforations 160 is provided inside chamber 152.

A first conductor 162 is provided on one side of chamber 152, preferably parallel to partition 158. A second conductor 164 is provided on another side of chamber 152, preferably parallel to first conductor 162. First conductor 162, second conductor 164 and partition 158 are connected to an alternating current (AC) power source 166. Chamber 152 and partition 158 are coated with an insulation film (not illustrated). A housing 168 supports mixer 150.

In this embodiment, the flow of fluid through inlet 154 and outlet 156 is perpendicular relative to the flow of fluid through chamber 152. A mixer with such an orientation is more suitable for installation in a tubular structure, such as a pipe. With reference to FIG. 6a, inlet 154 comprises a plurality of openings 170, 172 and 174, each of which receives a fluid to be mixed.

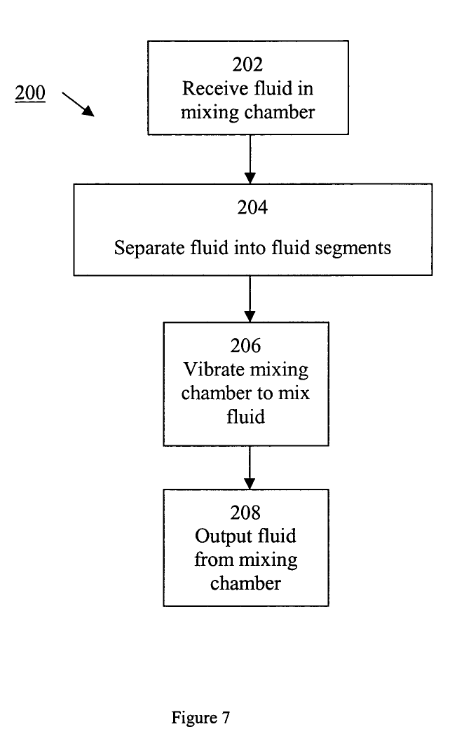

FIG. 7 illustrates a method 200 of mixing a fluid in accordance with one embodiment of the present invention. Method 200 begins at a block 202 when a fluid is received in a mixing chamber of a micromixer. While in the chamber, the fluid is separated in a block 204 into a plurality of fluid segments. The separation occurs when the fluid is forced to flow through a partition having a plurality of perforations. Separation of the fluid into fluid segments enhances mixing by lowering the diffusion distance between molecules in the fluid.

At the same time the fluid is being segmented in the present invention, the fluid is vibrated while it is in the mixing chamber in a block 206. The mixing is accomplished by utilizing a first conductor and a second conductor coupled to the mixing chamber. The conductors are coupled to an alternating current power source to generate a capacitance between the first conductor and the second conductor. The capacitance then causes the mixing chamber to vibrate to enhance fluid mixing. Alternatively, a capacitance may be generated between the partition and the conductors to further enhance fluid mixing. Finally, the fluid is outputted from the chamber in a block 208.

An advantage of the present invention is that the micromixer is effective for mixing a wide variety of fluids, particularly fluids with lower diffusion coefficients. By using a partition to split and separate the fluids into fluid segments, the present invention overcomes low diffusion coefficients by reducing the diffusion distance between the fluids to be mixed. The design of the micromixer inlets of the present invention also improves mixing by receiving the fluids in layered streams.

Another advantage of the present invention is that mixing occurs in an environment that is friendly towards sensitive fluids, such as bio-cells and liquids. Unlike micromixers of the prior art, the present invention accomplishes mixing by vibrating the fluids without generating either heat or any ultrasonic waves. The sensitive fluids are also insulated from electrical disruption. Additionally, the present invention does not require high voltages or frequencies for operation.

Other embodiments of the invention will be apparent to those skilled in the art from consideration of the specification and practice of the invention. Furthermore, certain terminology has been used for the purposes of descriptive clarity, and not to limit the present invention. The embodiments and preferred features described above should be considered exemplary, with the invention being defined by the appended claims.

1. A fluid mixer, comprising:
a chamber having an inlet and an outlet, wherein said inlet is to receive a fluid and said outlet is to output said fluid; and
a partition housed in said chamber, wherein said partition includes a plurality of perforations to segment said fluid.

2. The fluid mixer as recited in claim 1, further comprising a first conductor coupled to a first side of said chamber.

3. The fluid mixer as recited in claim 2, further comprising a second conductor coupled to a second side of said chamber.

4. The fluid mixer as recited in claim 3, further comprising an alternating current power source coupled to said first conductor and said second conductor, wherein said alternating current power source is to generate a capacitance between said first conductor and said second conductor.

5. The fluid mixer as recited in claim 4, wherein said fluid mixer is supported by a substrate and wherein said second conductor is coupled to said substrate.

6. The fluid mixer as recited in claim 5, wherein said first conductor is to vibrate said fluid.

7. The fluid mixer as recited in claim 3, wherein said first conductor is parallel to said second conductor.

8. The fluid mixer as recited in claim 4, wherein said partition is coated with an insulation layer.

9. The fluid mixer as recited in claim 8, wherein said partition is coupled to said alternating current power source to vibrate said partition.

10. The fluid mixer as recited in claim 9, wherein each of said perforations have a diameter of about ten times a diameter of a molecule in said fluid.

11. The fluid mixer as recited in claim 10, wherein said inlet includes a plurality of openings.

12. The fluid mixer as recited in claim 11, wherein said plurality of openings allows said fluid to enter said chamber in a plurality of layered streams.

13. The fluid mixer as recited in claim 2, wherein a flow of said fluid through said inlet and said outlet is perpendicular to a flow of said fluid through said chamber.

14. A method of mixing a fluid comprising:
receiving the fluid in a chamber;
separating said fluid into a plurality of fluid segments, wherein said separating lowers a diffusion distance of said fluid; and
outputting said fluid from said chamber.

15. The method of mixing as recited in claim 14, wherein said fluid is separated when said fluid flows through a partition having a plurality of perforations.

16. The method of mixing as recited in claim 15, further comprising vibrating said fluid, comprising:
providing a first conductor coupled to said chamber;
providing a second conductor coupled to said chamber; and
generating a capacitance between said first conductor and said second conductor.

17. The method of mixing as recited in claim 16, wherein said fluid is vibrated by generating an alternating current in said partition to vibrate said partition.

18. The method of mixing as recited in claim 17, wherein said fluid is received in layered streams.

19. The method of mixing as recited in claim 17, wherein each of said plurality of perforations is about ten times said diameter of a molecule in said fluid.

20. A fluid mixer, comprising:
a chamber having an inlet and an outlet, wherein said inlet is to receive a fluid and said outlet is to output said fluid;
a first conductor coupled to a first side of said chamber;
a second conductor coupled to a second side of said chamber; and
an alternating current power source coupled to said first conductor and said second conductor, wherein said alternating current power source is to generate a capacitance between said first conductor and said second conductor.

21. The fluid mixer as recited in claim 20, further comprising a partition housed in said chamber, wherein said partition includes a plurality of perforations to segment said fluid.

22. The fluid mixer as recited in claim 21, wherein said fluid mixer is supported by a substrate and wherein said second conductor is coupled to said substrate.

23. The fluid mixer as recited in claim 22, wherein said first conductor is to vibrate said fluid.

24. The fluid mixer as recited in claim 23, wherein said first conductor is parallel to said partition.

25. The fluid mixer as recited in claim 21, wherein said fluid mixer is supported by a housing and wherein said first conductor and said second conductor are coupled to the housing.

26. The fluid mixer as recited in claim 25, wherein said alternating power source is coupled to said partition to vibrate said partition.
